(19) United States
(12) Patent Application Publication
(10) Pub. No.: US 2025/0035475 A1
(43) Pub. Date: Jan. 30, 2025

(54) METERED DISPENSING ASSEMBLY

(71) Applicant: Lucas Packaging Group, Inc., Sussex, NJ (US)

(72) Inventor: Frank Francavilla, Sussex, NJ (US)

(21) Appl. No.: 18/783,311

(22) Filed: Jul. 24, 2024

Related U.S. Application Data
(60) Provisional application No. 63/515,169, filed on Jul. 24, 2023.

(51) Int. Cl. G01F 11/26

(52) U.S. Cl. CPC G01F 11/262

(57) ABSTRACT

Metered dispensing assemblies comprising: a receptacle; a dispensing tube; and one or more apertures on the portion of the dispensing tube that lies within the receptacle. The metered dispensing assemblies may engage a reservoir. Upon application of pressure to a fluid within the reservoir, the fluid may flow through the dispensing tube and through the one or more apertures to deposit in the receptacle. If the fill line of the fluid in the receptacle is above the one or more apertures when the pressure is released, the fluid will flow through the aperture and the dispensing tube into the reservoir, leaving a precise dosage remaining in the receptacle.

### CROSS REFERENCE TO RELATED APPLICATIONS

This U.S. Non-Provisional patent application claims the benefit of U.S. Provisional Patent Application No. 63/515,169 filed on Jul. 24, 2023, titled “LIQUID DISPENSING ASSEMBLY AND INSERT”, by inventor Frank Francavilla, the contents of which are expressly incorporated herein by this reference as though set forth in their entirety.

### FIELD OF USE

The present disclosure is generally directed to dispensing assemblies, and more specifically to metered dispensing assemblies that are configured to deliver precise amounts of fluid, or more preferably, a liquid.

### BACKGROUND

When dealing with chemicals for industrial, medical, or consumer purposes, precision of dosage is of paramount importance. Over-the-counter drugs, such as cough syrup, are often sold with a separate cup bearing a line marking a single dose. However, because a human must exercise judgment to fill the cup to said line, imprecision is inevitable. Further, the standalone receptacle may be lost, forcing consumers to guess the proper dosage in a different container, such as a tablespoon. Alternatively, machines that measure the dosage to an extremely high degree of accuracy exist, but are rarely utilized outside of laboratory or industrial environments due to the machines' cost, size, and complexity. Thus, what is needed is a metered dispensing assembly that is easy to use and inexpensive to produce while remaining precise in dosing.

### SUMMARY

To minimize the limitations in the prior art and to minimize other limitations that will become apparent upon reading and understanding the present specification, the present disclosure discloses new and useful devices, systems, and methods related to metered dispensing assemblies that deliver precise dosages.

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented herein below. It is to be understood that both the following general description and the following detailed description are exemplary and explanatory only and are not restrictive.

Various embodiments of the present disclosure may be directed to metered dispensing assemblies that deliver precise dosages. The metered dispensing assemblies may comprise a receptacle and a dispensing tube, wherein the portion of said dispensing tube extending into the receptacle may possess one or more apertures configured to allow fluid to flow from the receptacle into the dispensing tube, or vice versa. The dispensing tube may be hollow, and thus configured to allow fluid to flow from the receptacle to a reservoir, and vice versa. In some embodiments, the metered dispensing assembly may further comprise a collar, wherein the collar may be configured to attach the metered dispensing assembly to the reservoir and to a reservoir neck. The collar may be substantially any shape or form that allows fitting of the metered dispensing assembly to the reservoir neck, in either an airtight or porous manner. It is contemplated that the user, after affixing the metered dispensing assembly to the reservoir neck, may apply pressure to the reservoir, causing fluid to flow from the reservoir through the dispensing tube and deposit in the receptacle. Releasing the pressure on the reservoir will cause the fluid within the receptacle, and above the height of the one or more apertures, to flow back through the one or more apertures, into the dispensing tube, and then back into the reservoir. After this process has completed, the receptacle will contain a dosage approximately equal to the volume of the receptacle that lies below the one or more apertures.

In alternative embodiments, the metered dispensing assemblies may comprise a receptacle and an inner and an outer dispensing tube, wherein the portion of the inner dispensing tube extending into the receptacle may possess one or more apertures that allow fluid to flow from the receptacle into the dispensing tube, or vice versa. The inner dispensing tube and outer dispensing tube may be hollow, and thus configured to allow fluid to flow from the receptacle to a reservoir, and vice versa. In these embodiments, the inner dispensing tube and outer dispensing tube may be configured with an adjustable connection, or may otherwise be adjustable, to allow the position of the inner dispensing tube to vary in relation to the outer dispensing tube and the receptacle, thus varying the height of the apertures. The metered dispensing assembly may further comprise a collar, wherein the collar may be configured to attach the metered dispensing assembly to the reservoir and a reservoir neck. The collar may be substantially any shape or form that allows fitting of the metered dispensing assembly to the reservoir neck, in either an airtight or porous manner. It is contemplated that the user, after affixing the metered dispensing assembly to the reservoir neck, may apply pressure to the reservoir, causing fluid to flow from the reservoir through the dispensing tube and deposit in the receptacle. Releasing the pressure on the reservoir preferably causes the fluid within the receptacle, and above the height of the apertures, to flow back through the one or more apertures, into the inner dispensing tube, and then back into the reservoir. After the flow back process is completed, the receptacle preferably contains a dosage equal to, or approximately equal to, the volume of the receptacle below the apertures. In this embodiment, the variability of the height of the one or more apertures in relation to the receptacle allows the user to vary the resulting dosage contained in the receptacle.

The metered dispensing assemblies of the present disclosure may be comprised from the group of materials consisting of: metal, plastic, wood, stone, hemp, or composites and combinations thereof. The metered dispensing assemblies may be a unitary device, or it may be composed of multiple parts.

The metered dispensing assemblies of the present disclosure are novel because they enable the user to obtain precise dosages of a given fluid easily, with enhanced user control and case of use, at a lower cost compared with the currently available dosage devices. Additionally, the metered dispensing assemblies of the present disclosure offer superior flexibility to alternative metered dispensing options, because the collar is preferably able to engage with a wide range of reservoir neck types and sizes.

One embodiment may be a metered dispensing assembly comprising: a receptacle that comprises a distal end and a proximate end and a dispensing tube that comprises a distal end and a proximate end. The dispensing tube may comprise one or more apertures and the dispensing tube may extend through the proximate end of the receptacle. The apertures and the dispensing tube may be configured to allow a fluid to flow from a reservoir that contains a fluid to the receptacle. The apertures may be located on a section of the dispensing tube that is above the distal end of the receptacle and the section of the dispensing tube is below the proximate end of the receptacle. The metered dispensing assembly may also include a collar. The collar may be configured to allow the metered dispensing assembly to engage the reservoir without the metered dispensing assembly entirely entering the reservoir. The collar may be a protruding lip that substantially encircles an outer surface of the receptacle. The metered dispensing assembly may comprise materials selected from the group of materials consisting of: metal, plastic, wood, stone, hemp, composites, and/or combinations thereof. The one or more apertures may be located on an outer surface of the dispensing tube, and the distal end of the dispensing tube may be capped. The receptacle may comprise a first threaded portion and the dispensing tube may comprise a second threaded portion. The receptacle and the dispensing tube may rotably, or rotatably, engage one another through the first threaded portion and the second threaded portion.

Another embodiment may be a metered dispensing assembly comprising: a receptacle that comprises a distal end and a proximate end, an outer dispensing tube, an inner dispensing tube that comprises a distal end and a proximate end, and a collar. The inner dispensing tube may have an outer diameter that is less than an inner diameter of the outer tube, such that the inner dispensing tube may be configured to engage the outer dispensing tube. The inner dispensing tube may extend into the receptacle. The inner dispensing tube and the outer dispensing tube may comprise an adjustable connector, which may be configured to adjust the height of the inner dispensing tube in relation to the receptacle. The inner dispensing tube may comprise one or more apertures, and the one or more apertures may be located on a section of the dispensing tube that is above the distal end of the receptacle and below the proximate end of the receptacle. The one or more apertures and the dispensing tube may be configured to allow a fluid to flow between the receptacle and a reservoir that contains a fluid. The adjustable connector may comprise a threading on the inner dispensing tube and a corresponding groove on the outer dispensing tube. The outer dispensing tube and the receptacle may be individual components. The metered dispensing assembly may also include a collar. The collar may be configured to allow the metered dispensing assembly to engage the reservoir without the metered dispensing assembly entirely entering the reservoir. The collar may be a protruding lip that substantially encircles an outer surface of the receptacle. The metered dispensing assembly may comprise materials selected from the group of materials consisting of: metal, plastic, wood, stone, hemp, and/or composites and combinations thereof. The one or more apertures may be located on an outer surface of the inner dispensing tube, and the distal end of the inner dispensing tube may be capped.

Another embodiment may be a metered dispensing assembly comprising: a receptacle, a dispensing inner tube, a dispensing outer tube, and a collar. The inner dispensing tube may have an outer diameter that is less than an inner diameter of the outer tube, such that the inner dispensing tube may be configured to matingly engage with, and at least partially extend into, the outer dispensing tube. An outer surface of the inner dispensing tube may comprise a first threaded portion, and an inner surface of the outer dispensing tube may comprise a second threaded portion configured to engage the first threaded portion. The inner dispensing tube may extend into the receptacle. The inner dispensing tube and the outer dispensing tube has an adjustable connector configured to vary height of the inner dispensing tube in relation to the receptacle. The inner dispensing tube may comprise one or more apertures located on a section of the dispensing tube that may be above a distal end of the receptacle and below a proximate end of the receptacle. The one or more apertures and the dispensing tube may be configured to allow a fluid to flow between the receptacle and a reservoir that contains a fluid. The position of the one or more apertures in relation to the receptacle may allow a user to predetermine an amount of fluid to dispense from a reservoir into the receptacle. The collar may be a protruding lip that substantially encircles an outer surface of the receptacle and may be configured to allow the metered dispensing assembly to engage the reservoir without the metered dispensing assembly entirely entering the reservoir.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps, which are illustrated. When the same numeral appears in different drawings, it refers to the same or like components or steps.

FIG. 1 is an illustration of a perspective cross-sectional view of one embodiment of a metered dispensing assembly.

FIG. 2 is an illustration of a top perspective view of another embodiment of a metered dispensing assembly.

FIG. 3 is an illustration of a side cross-sectional view of one embodiment of a metered dispensing assembly.

FIG. 4 is an illustration of a side cross-sectional view of another embodiment of a metered dispensing assembly configured to allow variable dosing.

FIG. 5 is an illustration of a side view of another embodiment of a metered dispensing assembly.

FIG. 6 is an illustration of a perspective view of another embodiment of a metered dispensing assembly engaging a reservoir.

FIG. 7 is an illustration of a cross-sectional view of various embodiments of an adjustable connection between an inner dispensing tube and an outer dispensing tube.

FIG. 8 is an illustration of a cross-sectional view of another embodiment of a metered dispensing assembly.

### DETAILED DESCRIPTION OF THE ILLUSTRATIVE EMBODIMENTS

In the following detailed description of various embodiments of the present disclosure, numerous specific details are set forth in order to provide a thorough understanding of various aspects of one or more embodiments of the present disclosure. However, one or more embodiments of the present disclosure may be practiced without some or all of these specific details. In other instances, well-known methods, procedures, and/or components have not been described in detail so as not to unnecessarily obscure aspects of embodiments of the present disclosure.

While multiple embodiments are disclosed, still other embodiments of the devices, systems, and methods of the present disclosure will become apparent to those skilled in the art from the following detailed description, which shows and describes illustrative embodiments of the devices, systems, and methods of the present disclosure. As will be realized, the devices, systems, and methods of the present disclosure are capable of modifications in various obvious aspects, all without departing from the spirit and scope of the present disclosure. Accordingly, the screenshot figures, and the detailed descriptions thereof, are to be regarded as illustrative in nature and not restrictive. Also, the reference or non-reference to a particular embodiment of the devices, systems, and methods of the present disclosure shall not be interpreted to limit the scope of the present disclosure.

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-10% from the indicated number or range of numbers.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details.

Those skilled in the art will recognize many modifications may be made to this configuration without departing from the scope of the disclosed embodiments.

In the following description, certain terminology is used to describe certain features of the various embodiments of the device, method, and/or system. For example, as used herein, the term “receptacle” refers to a vessel of substantially any shape that is capable of containing a fluid.

As used herein, the term “dispensing tube” refers to a hollow cylinder configured to allow the flow of fluid.

As used herein, the term “aperture” refers to a hole, gap, perforation, or opening in a structure that may be substantially any shape that allows the flow of fluid.

As used herein, the term “reservoir neck” refers to the portion of a reservoir that allows access to the reservoir contents.

As used herein, the term “collar” refers to a method by which a device may engage a reservoir neck.

As used herein, the term “non-porous” refers to a structure through which fluid is prevented from flowing.

As used herein, the term “flow” refers to the spatial movement of fluid.

As used herein, the term “dosage” refers to the amount of fluid remaining in a receptacle after proper use of the metered dispensing assemblies of the present disclosure.

As used herein, the term “fluid” refers to a substance selected from the group comprising liquids either homogenous or non-homogenous, fine sands, solutions, or combinations or compositions thereof.

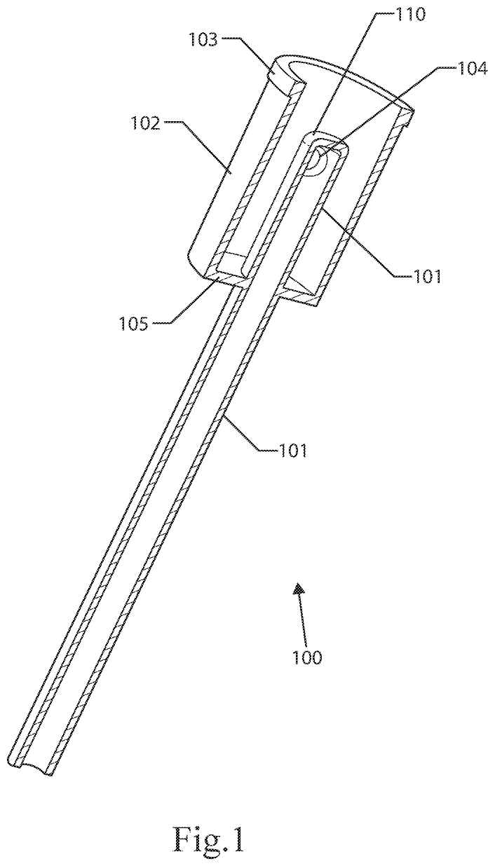

FIG. 1 is an illustration of a perspective cross-sectional view of one embodiment of a metered dispensing assembly. As shown in FIG. 1, metered dispensing assembly 100 may comprise dispensing tube 101, receptacle 102 with proximate end 105, aperture 104, and collar 103.

Dispensing tube 101 may be configured to extend through the proximate end 105 of receptacle 102 while remaining non-porous. As shown, dispensing tube 101 may be hollow and preferably allows the flow of fluid from the bottom to the top, and vice versa. In various embodiments, distal end 110 of dispensing tube 101 may be configured to be non-porous.

Aperture 104, as shown, may be located on a section of dispensing tube 101 that is situated, relatively, below collar 103 and above proximate end 105.

As shown in FIG. 1, collar 103 may be a protruding lip that encircles the distal end of receptacle 102. When attached to a reservoir neck, collar 103 prevents the metered dispensing assembly 100 from entering, or falling into, the reservoir.

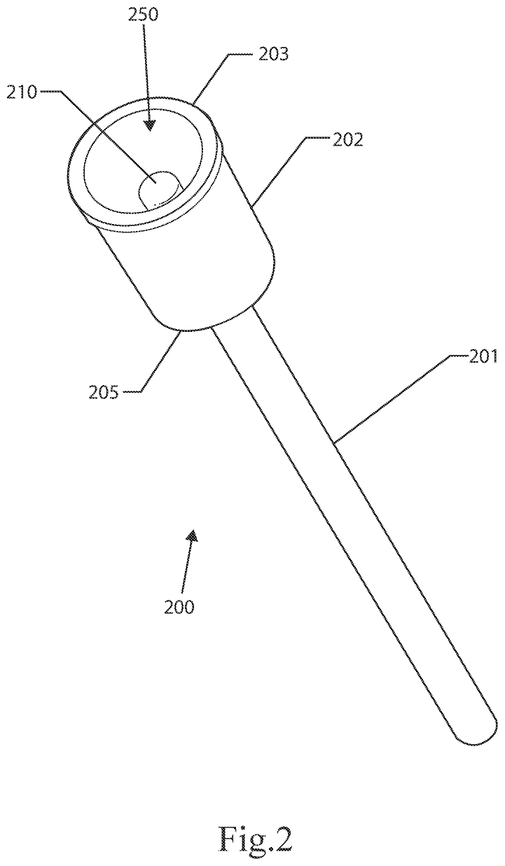

FIG. 2 is an illustration of a top perspective view of another embodiment of a metered dispensing assembly. As shown in FIG. 2, metered dispensing assembly 200 may comprise dispensing tube 201, receptacle 202 with proximate end 205, and collar 203.

Dispensing tube 201 may be configured to extend through proximate end 205 of receptacle 202 while remaining non-porous. Dispensing tube 201 may be hollow and allow the flow of fluid. In this specific embodiment, the distal end of dispensing tube 210 is configured to be non-porous.

As shown in FIG. 2, receptacle 202 may be non-porous and comprises an empty volume 250 configured to contain fluid.

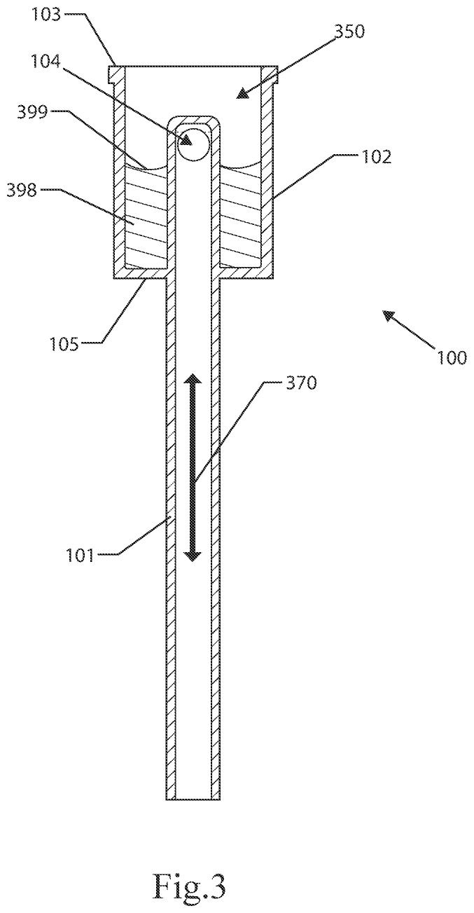

FIG. 3 is an illustration of a side cross-sectional view of one embodiment of a metered dispensing assembly. As shown in FIG. 3, metered dispensing assembly 100 may comprise dispensing tube 101 with one or more apertures 104, receptacle 102, and collar 103. Dispensing tube 101 may extend through proximate end 105 of receptacle 102. Aperture 104, as shown, may be located on a section of dispensing tube 101 that is situated, relatively, below collar 103 and above proximate end 105.

As shown in FIG. 3, dispensing tube 101 may be hollow and allow the flow of fluid 370 either toward or away from receptacle 102.

As shown in FIG. 3, if a fluid contained in fluid containment portion 350 of receptacle 102 rises above fluid level 399, the fluid may flow into one or more apertures 104, subsequently flow through 370 dispensing tube 101, and leave a precise dosage of fluid 398 in receptacle 102.

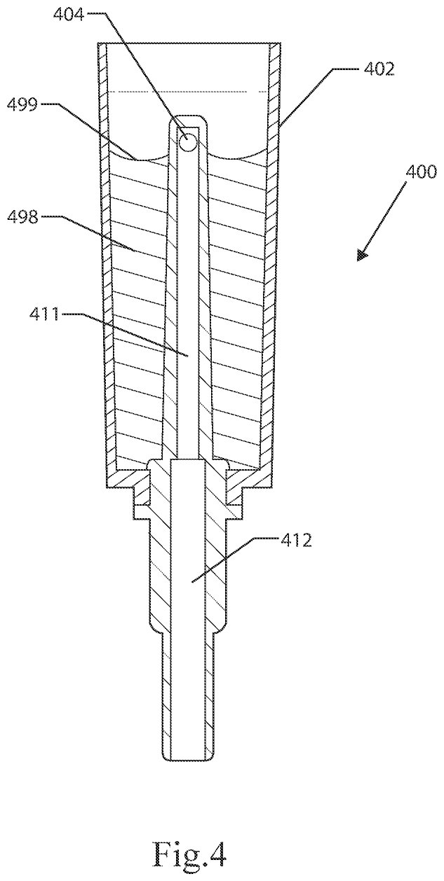

FIG. 4 is an illustration of a side cross-sectional view of another embodiment of a metered dispensing assembly configured to allow variable dosing. As shown in FIG. 4, the metered dispensing assembly 400 may comprise receptacle 402, inner dispensing tube 411, one or more apertures 404, and outer dispensing tube 412.

As shown in FIG. 4, inner dispensing tube 411 may be located partially within outer dispensing tube 412. Inner dispensing tube 411 may have an adjustable connection with outer dispensing tube 412. In this configuration, inner dispensing tube 411 may raise or lower in relation to outer dispensing tube 412, which has a fixed position in relation to receptacle 402.

By raising or lowering inner dispensing tube 411, the height of apertures 404 may vary in relation to receptacle 402, thereby varying the height of dosage line 499 and the precise final dosage 498. In various embodiments, the adjustable connection may comprise a telescoping tube, wherein sections of the tube may have progressively smaller diameters, such that the tube sections may enter each other. By this method, parts of the tube may be collapsed to adjust the height of the apertures and control the dosage. The adjustable connection may comprise a detent style locking mechanism, in which a spring urges one or more blocking components into one or more detents. The adjustable connection may comprise a magnet system, in which a magnet in the inner dispensing tube may be configured to resist a magnet in the outer dispensing tube. The adjustable connection may comprise a friction-based method, in which the inner tube is held in place by friction with the inner surface of the outer tube.

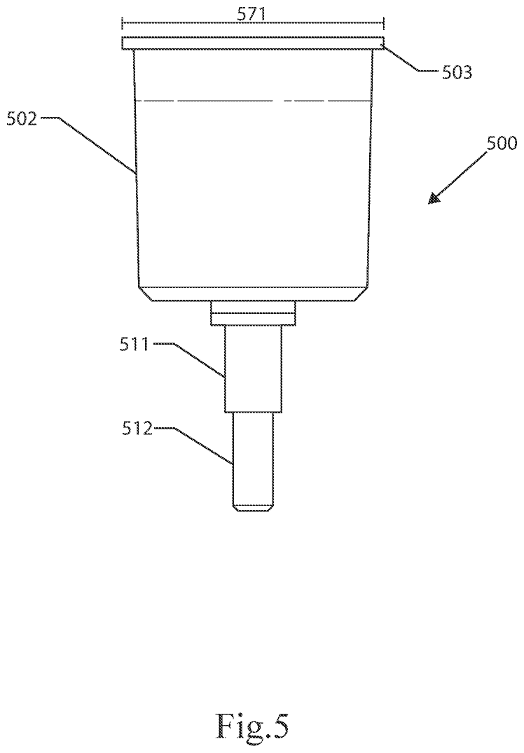

FIG. 5 is an illustration of a side view of another embodiment of a metered dispensing assembly. As shown in FIG. 5, metered dispensing assembly 500 may comprise a receptacle 502, an inner dispensing tube 511, an outer dispensing tube 512, and a collar 503.

As shown in FIG. 5, collar 503 may be a protruding rim, preventing the metered dispensing assembly from entering a reservoir so long as the diameter of a reservoir neck is less than the diameter 571 of the collar 503.

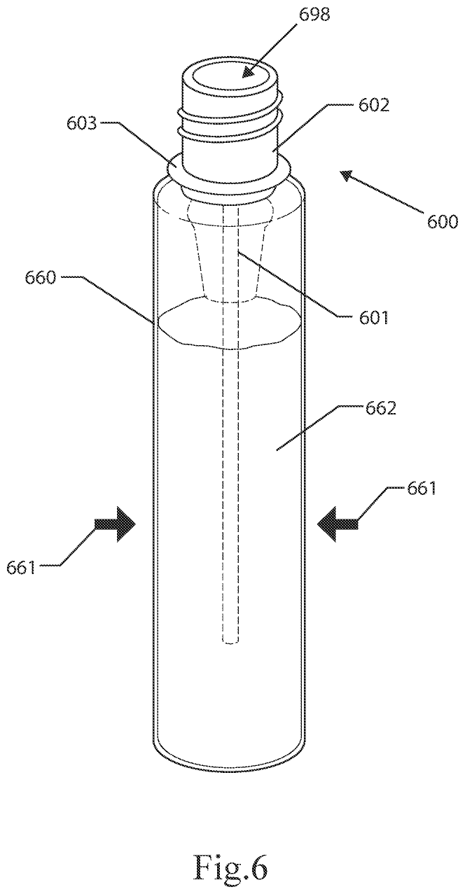

FIG. 6 is an illustration of a perspective view of another embodiment of a metered dispensing assembly engaging a reservoir. As shown in FIG. 6, metered dispensing assembly 600 may engage reservoir 660 containing fluid 662, and pressure 661 may be applied to reservoir 660 and fluid 662.

To engage reservoir 660, the user may insert metered dispensing assembly 600 into reservoir 660. Preferably, collar 603, here located at the proximate end of metered dispensing assembly 600, may prevent metered dispensing assembly 600 from entering, or falling, into reservoir 660.

After metered dispensing assembly 600 has engaged reservoir 660, pressure 661 may be applied in any manner, including, but not limited to, a squeeze of a user's hand. In one preferable method of use, a user may apply pressure 661 with the squeeze of a hand. Under pressure 661, fluid 662 in reservoir 660 may flow up inner dispensing tube 601 to deposit in receptacle 602, creating fluid deposit 698. Preferably, fluid deposit 698 will have a fluid level higher than an aperture.

Upon release of pressure 661, the portion of fluid deposit 698 above an aperture may flow down through dispensing tube 601 and into reservoir 660. After the portion of fluid deposit 698 above an aperture has returned to reservoir 660 and rejoined fluid 662, the fluid deposit 698 remaining in receptacle 602 may be a precise, predetermined dosage. Once fluid deposit 698 is the correct or desired volume, the user may remove metered dispensing assembly 600 and utilize the precise dosage of fluid deposit 698. In some embodiments, the user may pour the predetermined dosage directly from the metered dispensing assembly 600. In some embodiments, the metered dispensing assembly 600 may somewhat securely engage the reservoir 660 so that the metered dispensing assembly 600 does not fall out of the reservoir 660 when tilted to pour.

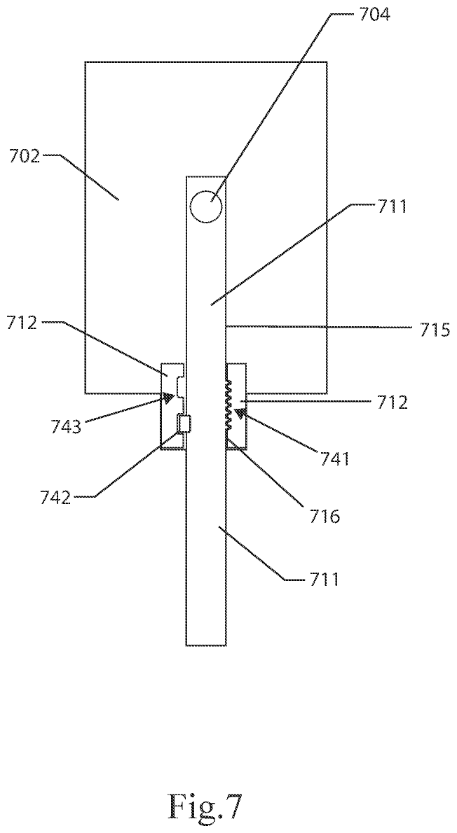

FIG. 7 is an illustration of a cross-sectional view of multiple embodiments of an adjustable connection between inner dispensing tube 711 and outer dispensing tube 712. As shown in FIG. 7, one embodiment of an adjustable connection may comprise screw threading 741 on inner dispensing tube 711 configured to engage outer dispensing tube 712. When rotated angularly, inner dispensing tube 711 may vary height in relation to outer dispensing tube 712, and thus aperture 704 may vary height in relation to receptacle 702.

As shown in FIG. 7, one embodiment of an adjustable connection may comprise blocking component 743 on inner dispensing tube 711, and mating detent 742 on outer dispensing tube 712. This adjustable connection method may preferably allow one or more aperture 704 heights in relation to receptacle 702 to be set at corresponding alignments of blocking component 743 and mating detent 742.

In this embodiment, adjustable screw connector 741 may threadingly engage outer surface 715 of inner dispensing tube 711 with inner surface 716 of outer dispensing tube 712. In this configuration, inner dispensing tube 711 may be twisted in relation to outer dispensing tube 712, or vice versa. Under this angular rotation, or twisting, adjustable screw connector 741 may be configured to adjust the height of inner dispensing tube 711, and/or the height of aperture 704, in relation to the base of outer dispensing tube 712. Further, adjustable screw connector 741 may be configured to fasten together inner dispensing tube 711 and outer dispensing tube 712.

In alternate embodiments, functionality and structures of outer dispensing tube 712 may be integrated into receptacle 702, such as threading.

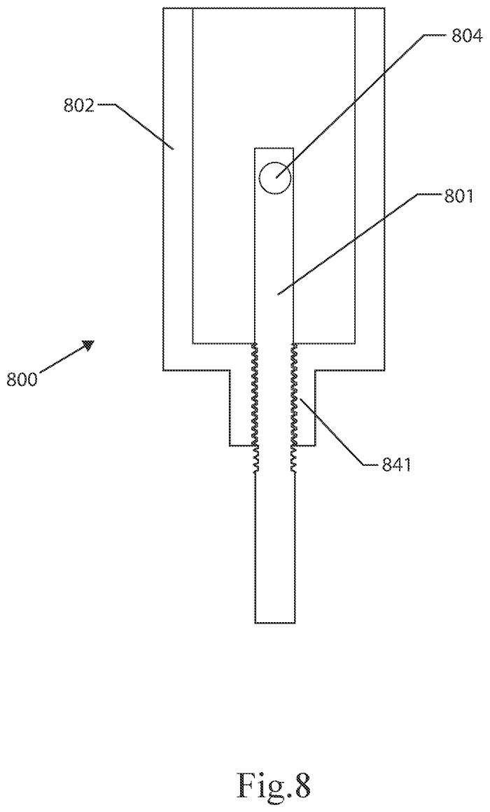

FIG. 8 is an illustration of a cross-sectional view of one embodiment of a metered dispensing assembly 800 that may be configured to allow an adjustable connection between dispensing tube 801 and receptacle 802 at a base of receptacle 802. As shown in FIG. 8, this embodiment may comprise adjustable screw connector 841, receptacle 802, aperture 804, and dispensing tube 801. As shown, receptacle 802, at the base of receptacle 802, may threadingly engage dispensing tube 801, such that dispensing tube 801 may be angularly rotated, twisted, or screwed, in relation to receptacle 802. Under this angular rotation, adjustable screw connector 841 may be configured to adjust the height of dispensing tube 801 and/or aperture 804 in relation to the base of receptacle 802. Further, adjustable screw connector 841 may be configured to fasten, in a fluid tight manner, dispensing tube 801 and receptacle 802.

The foregoing description of the preferred embodiment has been presented for the purposes of illustration and description. While multiple embodiments are disclosed, still other embodiments will become apparent to those skilled in the art from the above detailed description. These embodiments are capable of modifications in various obvious aspects, all without departing from the spirit and scope of protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

What is claimed is:

1. A metered dispensing assembly comprising:
a receptacle that comprises a distal end and a proximate end; and
a dispensing tube that comprises a distal end and a proximate end;
wherein said dispensing tube comprises one or more apertures and said dispensing tube extends through said proximate end of said receptacle;
wherein said one or more apertures and said dispensing tube are configured to allow a fluid to flow from a reservoir that contains a fluid to said receptacle; and
wherein said one or more apertures are located on a section of said dispensing tube that is above said distal end of said receptacle and said section of said dispensing tube is below said proximate end of said receptacle.

2. The metered dispensing assembly of claim 1, further comprising a collar.

3. The metered dispensing assembly of claim 2, wherein said collar is configured to allow said metered dispensing assembly to engage said reservoir without said metered dispensing assembly entirely entering said reservoir.

4. The metered dispensing assembly of claim 2, wherein said collar is a protruding lip that substantially encircles an outer surface of said receptacle.

5. The metered dispensing assembly of claim 1, wherein said metered dispensing assembly is made from materials selected from the group of materials consisting of: metal; plastic; wood; stone; hemp; composites; and combinations thereof.

6. The metered dispensing assembly of claim 1, wherein said one or more apertures are located on an outer surface of said dispensing tube and said distal end of said dispensing tube is capped.

7. The metered dispensing assembly of claim 1, wherein said receptacle comprises a first threaded portion and said dispensing tube comprises a second threaded portion; and wherein said receptacle and said dispensing tube rotably engage one another through said first threaded portion and said second threaded portion.

8. A metered dispensing assembly comprising:
a receptacle comprising a distal end and a proximate end;
an outer dispensing tube;
an inner dispensing tube comprising a distal end and a proximate end; and
a collar;
wherein said inner dispensing tube has an outer diameter that is less than an inner diameter of said outer tube, such that said inner dispensing tube is configured to engage said outer dispensing tube;
wherein said inner dispensing tube extends into said receptacle;
wherein said inner dispensing tube and said outer dispensing tube comprise an adjustable connector configured to adjust a height of said inner dispensing tube in relation to said receptacle;
wherein said inner dispensing tube comprises one or more apertures;
wherein said one or more apertures are located on a section of said dispensing tube that is above said distal end of said receptacle and that is below said proximate end of said receptacle; and
wherein said one or more apertures and said dispensing tube are configured to allow a fluid to flow between said receptacle and a reservoir that contains a fluid.

9. The metered dispensing assembly of claim 8, wherein said adjustable connector comprises a threading on said inner dispensing tube, and a corresponding groove on said outer dispensing tube.

10. The metered dispensing assembly of claim 8, wherein said outer dispensing tube and said receptacle are individual components.

11. The metered dispensing assembly of claim 8, wherein said metered dispensing assembly further comprises a collar.

12. The metered dispensing assembly of claim 8, wherein said collar is configured to allow said metered dispensing assembly to engage said reservoir without said metered dispensing assembly entirely entering said reservoir.

13. The metered dispensing assembly of claim 12, wherein said collar is a protruding lip that substantially encircles an outer surface of said receptacle.

14. The metered dispensing assembly of claim 12, is made from materials selected from the group of materials consisting of: metal; plastic; wood; stone; hemp; composites; and combinations thereof.

15. The metered dispensing assembly of claim 9, wherein said one or more apertures are located on an outer surface of said inner dispensing tube and said distal end of said inner dispensing tube is capped.

16. A metered dispensing assembly comprising:
a receptacle;
a dispensing inner tube;
a dispensing outer tube; and
a collar;
wherein said inner dispensing tube has an outer diameter that is less than an inner diameter of said outer tube, such that said inner dispensing tube is configured to matingly engage with, and at least partially extends into, said outer dispensing tube;
wherein an outer surface of said inner dispensing tube comprises a first threaded portion;
wherein an inner surface of said outer dispensing tube comprises a second threaded portion configured to engage said first threaded portion;
wherein said inner dispensing tube extends into said receptacle;
wherein said inner dispensing tube and said outer dispensing tube has an adjustable connector configured to vary a height of said inner dispensing tube in relation to said receptacle;
wherein said inner dispensing tube comprises one or more apertures;
wherein said one or more apertures are located on a section of said dispensing tube that is above a distal end of said receptacle and that is below a proximate end of said receptacle;
wherein said one or more apertures and said dispensing tube are configured to allow a fluid to flow between said receptacle and a reservoir that contains a fluid;
wherein a position of said one or more apertures in relation to said receptacle allows a user to predetermine an amount of fluid to dispense from a reservoir into said receptacle;
wherein said collar is a protruding lip that substantially encircles an outer surface of said receptacle; and
wherein said collar is configured to allow said metered dispensing assembly to engage said reservoir without said metered dispensing assembly entirely entering said reservoir.
